(19) United States
(12) Patent Application Publication
(10) Pub. No.: US 2009/0249174 A1
(43) Pub. Date: Oct. 1, 2009

(54) Fault Tolerant Self-Correcting Non-Glitching Low Power Circuit for Static and Dynamic Data Storage

(75) Inventor: Kirk David Lamb, Kingston, NY (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/060,593

(22) Filed: Apr. 1, 2008

(51) Int. Cl. G06F 7/04; G06F 11/07

(52) U.S. Cl. 714/819; 714/E11.024

(57) ABSTRACT

In a computer system in which personalization data for an ASIC is stored in latches, this data is susceptible to soft errors. Many computer systems require high levels of error detection, error correction, fault isolation, fault tolerance, and self-healing. In order to complete an ASIC design and release it to a foundry, it must first be verified that the design meets the frequency requirements of its specification. A fault tolerant, self-correcting, non-glitching, low power circuit is described which meets all the requirements for reliability, while also eliminating any requirement to add area or power to the ASIC in order to meet the frequency specification for personalization latches. By using the circuits as a repeatable structure, the verification of the self-healing property is simplified relative to a collection of Error Correction Code usages of various bit widths.

### BACKGROUND OF THE INVENTION

1. Field of the Invention

This invention relates to error detection, error correction, and self-healing in computer systems, and particularly to error detection, correction, and self-healing of static personalization bits in systems which require high levels of fault tolerance:

2. Description of Background

Background information on fault tolerant devices maybe found in multiple patents related to error detection and correction, such as, U.S. Pat. No. 5,682,394 and U.S. Pat. No. 5,533,036 which describe fault-tolerant memory subsystems with both system and unit (chip) level ECC, and how the systems can be made more fault tolerant by disabling unit level ECC in order to enable a system level complement/re-complement algorithm. US Application 2004/0199813 describes a self-correcting computer, in which multiple processors execute the same tasks in parallel, and a higher level controller compares their results, applies majority voting, takes checkpoints, and restarts them if an error is detected. In IBM Technical Bulletin number 12 5-91 pages 475-476 describes a single bit error counter which is useful for diagnostic information about single bit errors which have occurred in a circuit, chip, or system which performs single-bit error correction.

Additional background information is contained in a variety of patents, such as U.S. Pat. No. 5,537,655 which describes a fault tolerant method of providing a reset to multiple components that are used in a system majority voting implementation, patent U.S. Pat. No. 5,377,205 which describes a fault tolerant clock implementation with respect to a synchronized reset, US 2006/0143513 patent application which describes a method of maintaining cache coherency when a self-correcting computer is resynchronized. As well as Japan patents JP03233733A which describes error correction on the instruction queue of a microcomputer, and JP05282168A which describes improving the environmental tolerance of a computer by detecting environmental conditions which might contribute to increasing the number of errors in a system.

In VLSI design, clocked latches are used to store information. These latches are subject to both hard errors (stuck faults) and soft errors. Soft errors can occur due to a high-energy subatomic particle traversing the silicon, causing the latch to change state. When the latch changes state, an error has been introduced into the chip.

Desired qualities of any particular VLSI design are error detection, fault isolation, error correction, fault tolerance, and self-healing. The degree to which these qualities are desired or required depends upon the system requirements. High end system designers expect an increasingly high level of these qualities designed into the VLSI components which are used to build a system. When a soft error occurs in a latch in a high end system, it is desirable that the VLSI designs detect and correct that soft error without requiring higher level intervention, such as from a service processor.

Some VLSI designs contain a large number of personalization (or configuration) bits stored in latches. These latches are typically written once at system initialization time, and do not subsequently change. A large benefit is obtained in such designs by not requiring the outputs of these latches to make cycle-to-cycle timing. If such paths must be timed cycle-to-cycle, it will result in increased power and area requirements of the VLSI design, which increases cost. Such paths may become the design frequency limiting paths, decreasing performance. In addition, the design effort to close timing on such paths will increase both time to market and the staffing costs required to release the design, increasing costs and decreasing revenue.

Other examples of known methods of error detection are parity checkers, which detect single bit errors, and other more complex detection algorithms which are usually part of error-checking-and-correcting (ECC) codes. ECC codes can detect an arbitrarily high number of errors, at increasing cost in algorithm complexity, implementation, and verification as the number of errors detected increases.

Additional example of a known method for error correction and fault tolerance is the class of ECC codes, which correct errors in addition to checking for them. Another method is double-redundant data with parity checking. In such a scheme two copies of the data are held, both checked by parity. If one parity checker detects an error, the other copy is used. Another technique is triple redundancy with voting. The ECC and double-redundant data schemes operate typically on a set of latches, rather than one latch, and become more expensive as the numbers of bits covered decreases. Double-redundant data, for example, can be applied at a bit level, but in that case it would require four latches per bit of information, which would be more expensive and less effective than triple-redundancy. The cost of triple redundancy scales linearly with the number of bits.

If error correction is performed but the bit in error remains in error (corrected but not healed) then the correction scheme is weakened. A single-error correction, double-error detection scheme (SECDED) becomes single-error detection (SED) with no correction, for example.

### SUMMARY OF THE INVENTION

Before the present invention, attaining error detection, correction, and self-healing on static personalization bits of an ASIC was problematic. Some ASIC's have thousands of personalization bits which are programmed via BIOS or firmware when the system is initialized, but are never written again. Once written they are intended to hold their value until the machine is initialized again, which may be never.

In order to release an ASIC to the foundry for production, the design team must first verify that the static timing requirements are met: that the latch-to-latch timing in the ASIC meets the frequency requirements of the system for which the ASIC is designed. If the system requires fault tolerance, ECC must be applied downstream of the personalization latches to correct any latch flips which may occur. If the system requires self-healing, the feedback path to those latches must also have ECC. Because the outputs of the ECC network can glitch as a correction is performed, those paths must be verified in static timing. Closing timing on those paths typically requires increases in ASIC power and area required for the ASIC, and increases time to market and staffing costs, or both.

The present invention eliminates the need to perform static timing on ASIC personalization latches. Since a verified macro can be re-used for each personalization bit, the verification costs of ensuring that errors are detected and corrected is also reduced. In addition, a low power implementation of the circuit is also described which reduces power consumption of the circuit.

By using a bit-basis (triple redundancy, for example, or another “majority voting” scheme) rather than group-of-bits-basis (ECC) solution to the problem, design implementation and verification costs can be significantly reduced. If an ECC scheme is used, for example, unique ECC schemes would have to be found, implemented, and verified for every unique number of bits requiring coverage.

From the perspective of cycle-to-cycle timing, the ECC and double-redundancy schemes have a drawback. When a soft error occurs, there is a finite period of time required in order for the error correction to take place. If a majority voting circuit is used in a triple-redundancy scheme, the correction is instantaneous. The majority voting circuit corrects for a single-bit error and guarantees that the circuit output does not glitch.

The present invention is an implementation of error detection and correction which enables VLSI designers to implement personalization bits with a repeatable structure, maintains the benefit of not requiring cycle-to-cycle timing of personalization data, and provides for self-correction of soft errors.

Although this invention is primarily intended to solve the problem of error correction and self-healing while enabling the benefit of not requiring cycle-to-cycle timing closure on configuration latches, it is applicable to all latch usages, not just configuration latches. Another expected usage is in the implementation of the state latches of critical finite state machines with a one-hot error checker. Such state machines could be made fault tolerant. Cycle to cycle timing closure in this case would be required, however.

The shortcomings of the prior art are overcome and additional advantages are provided through the provision of implementing personalization bits in a VLSI design using the fault tolerant self-correcting non-glitching low power (hereinafter referred to as “FT SC NG LP”) macro. Through its use, a VLSI design can achieve the goals of fault tolerance and error correction, eliminating the power and area costs required to close cycle-to-cycle timing, and minimizing design and verification costs of other error correction and detection methods which operate on groups of registers, rather than individual latches.

Accordingly it is an object of the present invention to decrease the power and area requirements of a VLSI design by not requiring the outputs to make cycle to cycle timing.

It is a further object to detect and correct errors in VLSI designs without requiring higher level intervention, such as from a service processor.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a block diagram of an example of a fault-tolerant self-correcting non-glitching FT SC NG LP macro in accordance to the present invention;

FIG. 2A illustrates an example of a majority voting circuit and FIG. 2B illustrates unanimity failure detection circuit in accordance to the present invention shown FIG. 1:

FIG. 3A illustrates a typical “load-hold” latch implementation, and FIG. 3B its analogous implementation using a FT SC NG LP macro in accordance with the present invention; and

FIG. 4A illustrates a low power implementation of a typical “load-hold” latch, and FIG. 4B its analogous implementation using a FT SC NG LP macro in accordance with the present invention;

The detailed description explains the preferred embodiments of the present invention, together with advantages and features, by way of example with reference to the drawings.

### DETAILED DESCRIPTION OF THE INVENTION

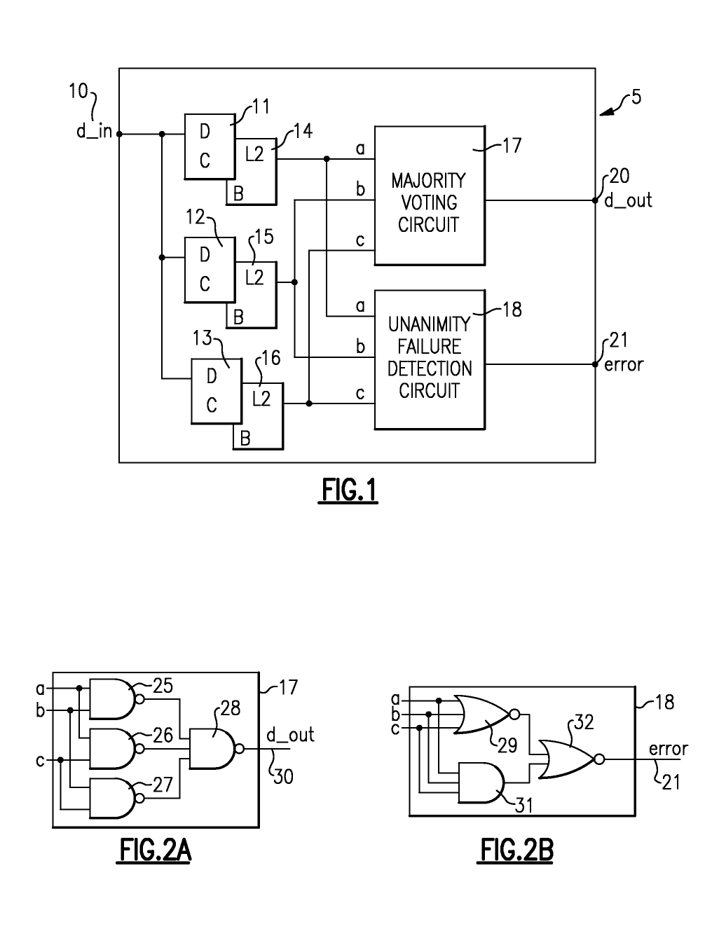

Turning now to the drawings in greater detail, FIG. 1 illustrates a FT SC NG LP macro 5 in accordance with the present invention with a single data input d_in 10 having three latches. The latches are shown divided into their capture components (11, 12, and 13) and launch components (14, 15 and 16). They could also be represented as flip-flops, in which case the capture and launch components would be shown as a single block. Each of the latches sends a signal to the input of a majority voting circuit 17 and a unanimity failure detection circuit 18 which is described in more detail hereinafter. The output being a data output (d_out) 20 as a result of non-glitching majority vote or an error output 21 as a detection of a failure to obtain unanimity. The macro 5 is designed to handle a single soft error (single bit flip). The main points are that triplication of the data is required, that d_out 20 is the result of a non-glitching majority vote, and that error output 21 is the detection of a failure to obtain unanimity. It should be appreciated, if a double bit flip were possible, then the majority voting circuit would require quintiplucation of the data, and the majority vote would be three-out-of-five, rather than two-out-of-three. It therefore should be understood that the same principle holds true regardless of the maximum number of bits which are assumed to potentially flip. If the number of bits that can potentially flip is n, then the majority voting circuit requires 2n+1 copies of the information to be used.

FIG. 2 illustrates an example of an implementation of the voting circuit 17 in FIG. 2A and the detection of a failure to obtain unanimity circuit 18 shown in FIG. 2B respectively which were discussed above. Other implementations of other circuits that can perform similar functions are of course also possible. As shown in FIG. 2A three copies of input 10 are created a, b, and c of which copy a and b are provided to NAND gate 25, copy a and c are provided to NAND gate 26, and copy b and c are provided to NAND gate 27 each produces an output which are sent to NAND gate 28. Gate 28 sends the output signal 30, which is zero if two or more of three inputs are zero, and one if two or more of three inputs are one. A requirement of the majority voting circuit is that its output may not glitch if one and only one of the three inputs changes. These example circuits are for a system assuming no more than a single bit flip. If more than a single bit flip must be tolerated, then the majority voting circuit must be modified to increase the number of copies of the data. The failure to detect unanimity circuit would also have to be modified accordingly. For example, if the number of bits that can potentially flip is n, then the majority voting circuit requires 2n+1 copies of the information and 2n+1 gates to be used. As shown in FIG. 2B three copies of input 10 are created a, b, and c of which copy a, b, and c are provided to NOR gate 29, and a copy a, b, and c are provided to AND gate 31, and each gate produces an output which is sent to a NOR gate 32 for comparison. If all the copies are not the same gate 32 sends the output error signal.

The present inventive macro 5 described and shown in FIG. 1 above may be used in a variety of applications. An example of the operation in one such application would be where the data stored in macro 5 is used to the system to indicate “go into power-down mode”. In this example, d_out is 1, and to stay in normal operational mode if d_out is 0. d_in to macro 5 is 0, indicating that the system is to perform normal operations. Suppose that a soft error causes one of the launch components of one of the latches, gate 14 for example, to flip from a logic 0 to a logic 1. d_out would remain a logic 0 because inputs b and c to majority voting circuit 17 would still be logic 0. The system would tolerate the error. The error signal 21 would go active for one clock cycle, indicating that there was a failure to obtain unanimity for one clock period. As long as d_in remained logic 0, and clocks were active, gates 11 and 14 would be overwritten to a logic zero on the next clock edge. If circuit 5 had not been used, and the information had been stored in a single latch that had changed from logic 0 to logic 1 for one cycle, the VLSI components taking the signal “go into power-down mode” as an input would have falsely started the change of state to power-down mode, with unpredictable behavior and potential loss of data integrity.

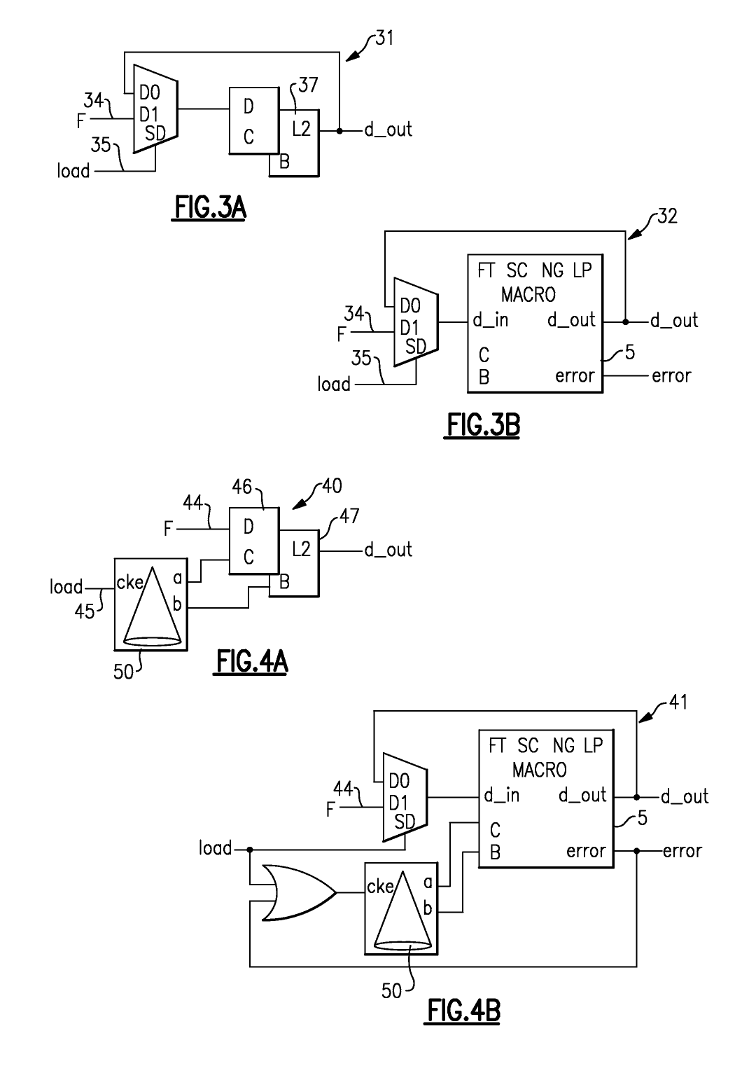

FIG. 3A illustrates a typical VLSI load-hold circuit 31 and FIG. 3B illustrates a similar VLSI circuit 32 utilizing the FT SC NG macro 5 in accordance with the present invention that was described above. In this application both circuits use free running clocks and no clock gating to reduce power. The circuit 31 captures a value F at the input 34 when load 35 is active and holds the value as d_out in the latch 37 until another load is applied. The circuit 32 also captures a value F at its input 34 when load 35 is active and holds the value as d_out until another load is applied.

In operation of using the circuit 32, for a case where F 34 is unknown for all times when load is inactive, and that F is 0 during the one clock period when load was active. This example is used to indicate a typical case where the system was initialized long ago to be in normal operation mode, and it will stay in that mode for the rest of time. The user of this system will never change to power-down mode. If one of the latches of the FT SC NG LP macro changes state to a logic 1 due to a soft error, the output will still stay at the correct value of logic 0. The error indicator will go active. The system will tolerate the error. In addition, it will self-heal even though the input F is undefined and the external load signal will never again go active. The latch that flipped state will be rewritten with the corrected output of the majority voting circuit, and returning it to the correct value.

FIG. 4A illustrates a typical VLSI load-hold circuit 40 in a low power implementation and FIG. 4B illustrates a similar VLSI circuit 41 utilizing the FT SC NG SH macro 5 in accordance with the present invention that was described above. These circuits are similar to those in FIG. 3 above but are a low power implementation which uses clock gating 50 to reduce power. The circuit 40 receives a value F at the input 44 to register 46 when load 45 is applied to the clock enable 50 which sends clocks to the latch components 46 and latch 47. With the exception of the clock gating for power savings, FIG. 3A is equivalent to FIG. 4A, and FIG. 3B is equivalent to 4B. In FIG. 4B, either the load signal or the error signal can turn the clocks on. The load signal turns the clocks on to update the contents of the latches with the value F in normal functional mode. If an error is detected, the error signal turns the clocks on. If the error signal turns clocks on and the load signal is 0, then the latches are updated with the corrected output of the majority voting circuit. If the load signal is 1, the latches are updated with a new value of F. In both cases this is the correct logical behavior

While the preferred embodiment to the invention has been described, it will be eighty understood that those skilled in the art, both now and in the future, may make various improvements and enhancements which fall within the scope of the claims which follow. These claims should be construed to maintain the proper protection for the invention first described.

What is claimed is:

1. A fault tolerant VLSI macro for storing data having an input and output comprising;
a plurality of storage means for receiving and storing x copies of data input to the macro;
a majority voting circuit which receives the n copies of data and outputs a value equivalent to that of the majority of the inputs;
an unanimity failure detection circuit which receives the x copies of data and determines if any of the copies of data is not identical; and
generating an error signal if all copies of the data are not identical.

2. The fault tolerant VLSI macro of claim 1 wherein the x copies depends on the number of bits that can potentially flip which is n.

3. The fault tolerant VLSI macro of claim 2 wherein x copies is determined to be equal to the sum of 2n+1.

4. The fault tolerant VLSI macro of claim 1 wherein the majority voting circuit includes 2n+1 NAND gates, each NAND gate receives a different set of two different copies of the data to be processed and the results of each NAND gate is sent to another NAND gate to output the results of the voting circuit.

5. The fault tolerant VLSI macro of claim 1 wherein the unanimity failure detection circuit includes one NOR gate and one AND gate which both receives the n copies of data and both gates is sent to a NOR gate to generate the error signal if all copies of the data are not identical.

6. The fault tolerant VLSI macro of claim 1 wherein the storage means includes capture and launch components.

7. The fault tolerant VLSI macro of claim 1 wherein the storage means includes n latches.

8. The fault tolerant VLSI macro of claim 1 wherein the storage means includes n flip-flops.

9. A method for processing data in a fault tolerant VLSI macro comprising:
storing data input the macro and
creating x copies of the data;
transmitting the x copies of data to inputs of a majority voting circuit which generates an output with a value equivalent to that of the majority of the inputs; and
transmitting the x copies of data to inputs of a unanimity failure detection circuit which generates an error signal if all copies of the data are not identical.

10. The method for processing data in the fault tolerant VLSI macro of claim 9 wherein the x copies depends on the number of bits that can potentially flip which is n.

11. The method for processing data in the fault tolerant VLSI macro of claim 10 wherein x copies is determined to be equal to the sum of 2n+1.

12. The method for processing data in the fault tolerant VLSI macro of claim 9 wherein the majority voting circuit includes 2n+1 NAND gates, each NAND gate receives a different set of two different copies of the data to be processed and the results of each NAND gate is sent to another NAND gate to output the results of the voting circuit.

13. The method for processing data in the fault tolerant VLSI macro of claim 9 wherein the unanimity failure detection circuit includes one NOR gate and one AND gate which both receives the n copies of data and both gates is sent to a NOR gate to generate the error signal if all copies of the data are not identical.

14. The method for processing data in the fault tolerant VLSI macro of claim 9 wherein the storing includes capture and launch components.

15. The method for processing data in the fault tolerant VLSI macro of claim 9 wherein the storing includes n latches.

16. The method for processing data in the fault tolerant VLSI macro of claim 1 wherein the storing includes n flip-flops.
